(19) United States
(12) Patent Application Publication
(10) Pub. No.: US 2011/0285646 A1
(43) Pub. Date: Nov. 24, 2011

(54) ELECTRONIC DEVICE WITH TOUCH PAD

(75) Inventors: KUAN-HONG HSIEH, Tu-Cheng (TW); LI-ZHANG HUANG, Tu-Cheng (TW); HAN-CHE WANG, Tu-Cheng (TW); CHUN-WEI PAN, Tu-Cheng (TW)

(73) Assignee: HON HAI PRECISION INDUSTRY CO., LTD., Tu-Cheng (TW)

(21) Appl. No.: 12/972,504

(22) Filed: Dec. 19, 2010

(30) Foreign Application Priority Data
May 19, 2010 (CN) 201010176723.9

(51) Int. Cl. G06F 3/041

(52) U.S. Cl. 345/173

(57) ABSTRACT

An electronic device includes a transparent touch pad, a switch module, a CPU, a touch control module, and a display control module. The switch module is configured to enable or disable the touch pad in response to user operations, and generate an operation signal. The operation signal is an enabling signal or a disabling signal. The CPU generates a control signal and a display signal upon receiving the enabling signal or the disabling signal from the switch module. The touch control module enables or disables the touch pad corresponding to the control signal, and the display control module controls to divide a display area into a first display area and a second display area to display content or recombine the first display area and second display area together and display the non-operable interface.

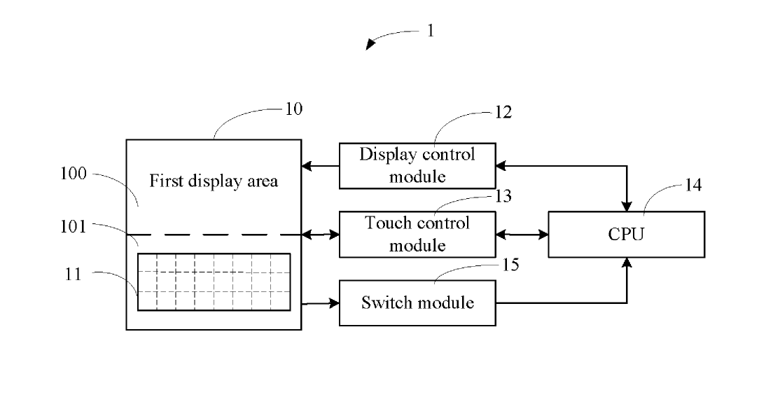

### BACKGROUND

1. Technical Field

The present disclosure relates generally to an electronic device with touch pad and, particularly, to an electronic device capable of displaying different contents on divided display screen.

2. Description of the Related Art

With many electronic devices having touch screens, the whole display area is normally covered by a transparent touch pad, which is costly.

Therefore, there is room for improvement within the art.

### BRIEF DESCRIPTION OF THE DRAWINGS

The components in the drawings are not necessarily drawn to scale, the emphasis instead being placed upon clearly illustrating the principles of an electronic device capable of displaying different contents on divided display screen. Moreover, in the drawings, like reference numerals designate corresponding parts throughout the several views.

The drawing is a block diagram of an electronic device in accordance with an exemplary embodiment.

### DETAILED DESCRIPTION

Referring to the drawing, the electronic device 1 includes a display screen 10, a transparent touch pad 11, a display control module 12, a touch control module 13, a central processing unit (CPU) 14, and a switch module 15. In an exemplary embodiment, the electronic device 1 is an electronic book reader with an electrophoretic display screen. The touch pad 11 can be any one of a capacitive touch screen (CTS), a resistive touch screen (RTS), an infrared touch screen, and on the like. The touch pad 11 has a touch area smaller than a display area of the display screen 10, therefore the touch area covers only part of the display area.

The switch module 15 is configured to enable or disable the touch pad 11 in response to user operation, and generate a corresponding operation signal, namely, an enabling signal or a disabling signal, to the CPU 14.

The CPU 14 is configured to generate a corresponding control signal upon receiving the operation signal sent by the switch module 15. Upon receiving an enabling signal, the CPU 14 signals the touch control module 13 to enable the touch pad 11. Conversely, if receiving a disabling signal, the CPU 14 signals the touch control module 13 to disable the touch pad 11.

The CPU 14 is further configured to generate a corresponding display signal to the display control module 12 upon receiving an enabling signal or a disabling signal. When receiving an enabling signal, the CPU 14 signals the display control module 12 to divide the display area into a first display area 100 and a second display area 101 and displays content in the display area. The second display 101 is located under the touch area of the touch pad 11 and is the same size as the touch area of the touch pad 11. The display control module 12 further displays a non-operable interface in the first display area 100 and displays an operable interface in the second display area 101. The non-operable interface shows content such as pictures, articles, messages and so on. The content is provided only for viewing. The operable interface shows operable items such as a virtual keyboard, operable by user with touch operations on the touch pad 11 to operate the electronic device 1. For example, the operable items may allow users to update the content in the first display area 100. Upon receiving a disabling signal, the CPU 14 signals the touch control module 13 to disable the touch pad 11. At the same time, the CPU 14 signals the display control module 12 to recombine the first display area 100 and the second display area 101 and together display the non-operable interface.

In another embodiment, the electronic device 1 further includes a color filter (CF). The CF is laid on the second display area 101, and between the touch pad 11 and the display screen 10. When the touch pad 11 is enabled, the second display area 101 displays a colored operation interface.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An electronic device, comprising:
a touch pad;
a display screen providing a display area partially covered by the touch pad;
a switch module configured to enable or disable the touch pad in response to user operation, and generate an operation signal, the operation signal is an enabling signal or a disenabling signal;
a central processing unit (CPU) configured to generate a control signal and a display signal upon receiving the enabling signal or the disenabling signal from the switch module;
a touch control module configured to enable or disable the touch pad corresponding to the control signal; and
a display control module configured to divide the display area into a first display area and a second display area to display content or recombine the first display area and second display area together and display the non-operable interface corresponding to the display signal.

2. The electronic device as recited in claim 1, wherein the touch pad has a touch area smaller than a display area of the display screen, and the touch area covers only part of the display area.

3. The electronic device as recited in claim 1, wherein upon receiving the enabling signal, the CPU signals the touch control module to enable the touch pad, and signals the display control module to divide the display area into the first display area and the second display area; upon receiving the disabling signal, the CPU signals the touch control module to disable the touch pad, and signals the display control module to recombine the first display area and the second display area.

4. The electronic device as recited in claim 1, wherein the second display is located under the touch area of the touch pad and is the same size as the touch area of the touch pad.

5. The electronic device as recited in claim 1, wherein the display control module is configured to display a non-operable interface in the first display area and display an operable interface in the second display area.

6. The electronic device as recited in claim 1, further comprising a color filter (CF), wherein the CF is laid on the second display area, and between the touch pad and the display screen.
